(19) United States
(12) Patent Application Publication
(10) Pub. No.: US 2018/0115560 A1
(43) Pub. Date: Apr. 26, 2018

(54) METHOD OF VERIFICATION

(71) Applicant: Incall Limited, London (GB)

(72) Inventors: Chaim Aaron James GREEN, London (GB); Joshua NYMAN, London (GB)

(21) Appl. No.: 15/682,582

(22) Filed: Aug. 22, 2017

(30) Foreign Application Priority Data
Aug. 22, 2016 (GB) 1614334.9

(51) Int. Cl. H04L 29/06

(52) U.S. Cl. CPC H04L 63/126; H04L 63/102; H04L 63/0876; H04L 63/0861; H04L 63/107; H04L 63/083

(57) ABSTRACT

The present invention relates to a method of verification of a communicating party. In particular, the invention relates to a method of verifying the identity of a communicating party at a user device, the method comprising the steps of receiving a communication at the user device, wherein the communication comprises information identifying the communicating party; determining whether the information identifying the communicating party comprises a variable authentication sequence indicative of the identity of the communicating party; and comparing the authentication sequence against at least one pre-determined criteria to determine whether the authentication sequence is valid, thereby to verify the identity of the communicating party.

### RELATED APPLICATION

This application claims the benefit of priority of United Kingdom Patent Application No. 1614334.9 filed Aug. 22, 2016, the contents of which are incorporated herein by reference in their entirety.

### FIELD AND BACKGROUND OF THE INVENTION

The present invention relates to a method of verification of a communicating party. More particularly, the present invention relates to a method of verification that mitigates the risk of a user being deceived as to the identity of a party to a telephone call using false caller identification information.

Caller identification (referred to as caller ID) is a service available in most analogue and digital telephone systems, as well as most voice over Internet Protocol (referred to as VoIP) systems. The service is typically arranged to transmit information indicative of a calling party's identity to a recipient's device, where the information is displayed or otherwise communicated to the recipient at least while the call is ringing (i.e. after the call has been signalled to the recipient, but before the recipient answers the call). The information is typically made up of the calling party's telephone number, which may be provided along with the calling party's name and/or other information related to the calling party's identity. The provision of such information may allow the user to make an informed decision about whether to answer the call based on the identity of the calling party.

Some caller ID systems are vulnerable to ‘spoofing’, in which the calling party manipulates the authentication mechanisms of the caller ID system, which are often weak or even non-existent, to change the caller ID information that is displayed at a recipient's phone. This may allow the calling party to deceive the recipient about the calling party's identity for malicious purposes. For example, the calling party may change the caller ID information to correspond with the identity of a call centre for a bank where the recipient is a customer. If the recipient is deceived, the calling party may be able to persuade the user to reveal sensitive information to the calling party, since the recipient believes that the calling party represents a known and trusted body.

Furthermore, various other communication systems, such as email and instant messaging systems are vulnerable to similar spoofing attacks, where a malicious party impersonates a user's contact using that contact's name or other identifying information.

Aspects and embodiments of the present invention are set out in the appended claims. These and other aspects and embodiments of the invention are also described herein.

### SUMMARY OF THE INVENTION

According to at least one aspect described herein, there is provided a method of verifying the identity of a communicating party at a user device, the method comprising the steps of: receiving a communication at the user device, wherein the communication comprises information identifying the communicating party; determining whether the information identifying the communicating party comprises an authentication sequence indicative of the identity of the communicating party; and comparing the authentication sequence against at least one pre-determined criteria to determine whether the authentication sequence is valid, thereby to verify the identity of the communicating party.

By authenticating based on an authentication sequence incorporated into information identifying the communicating party, a secure method of authentication is provided using only a single communication medium.

Optionally, the authentication sequence may be a variable authentication sequence. For example, a variable authentication sequence may be an authentication sequence that is selectable (and thus, may be selected) from a plurality of possible authentication sequences, optionally wherein the selection may be based on at least one property (examples of which are provided in more detail further on).

The method may comprise the further step of generating an authentication sequence using an algorithm, wherein the at least one pre-determined criteria are arranged so as to allow determination of whether the authentication sequence is a valid sequence generated by the algorithm.

The authentication sequence may be generated on the basis of one or more properties associated with the user device and/or user. The one or more properties may comprise one or more of: a property associated with the user device, an app user identification number, a user telephone IMEI (International Mobile Equipment Identity) number, a user telephone number, or a secret key associated with the user.

The authentication sequence may be generated on the basis of one or more dynamic properties. At least one of the dynamic properties may relate to time. The one or more dynamic properties may comprise one or more of: a time of a day, a day of a week, or a date.

The at least one pre-determined criteria may comprise a further algorithm being arranged to determine whether the authentication sequence is a valid sequence generated by the algorithm. The further algorithm is arranged to calculate an inverse function of the algorithm. The further algorithm may be arranged to determine whether the authentication sequence is a valid sequence based on the same properties that the authentication sequence is based on, wherein the properties are calculated independently by the algorithm and the further algorithm. The method may further comprise updating the at least one pre-determined criteria in dependence on changes to the algorithm.

In an alternative, the method may comprise the further step of generating the authentication sequence at random. The authentication sequence may be generated by the communicating party. The method may comprise the further step of communicating the authentication sequence to the user device.

Alternatively, the authentication sequence may be generated by the user device. The method may comprise the further step of communicating the authentication sequence to the communicating party.

The at least one pre-determined criteria may comprise a list of possible valid authentication sequences.

The method may comprise the further steps of modifying the communication such that the authentication sequence is incorporated into the information identifying the communicating party; and transmitting the modified communication to the user device.

The communication may be a telephone call and the information identifying the communicating party may be caller ID. Modifying a communication may comprise selecting a telephone number from a list of telephone numbers available to the communicating party, wherein the selected telephone number incorporates the authentication sequence. Modifying the communication may comprise assuming an artificial caller ID for the telephone call, wherein the assumed artificial caller ID incorporates the authentication sequence. The assumed artificial caller ID may be in an invalid format for a telephone number. The assumed artificial caller ID may be arranged so as to look like a valid telephone number. The method may comprise the further step of displaying whether the identity of the communicating party has been verified on an incoming call screen of the user device.

Alternatively, the communication may be one of: an email, an instant message, a text message, a video message, and an audio message. The method may comprise the further step of verifying the identity of the communicating party in relation to subsequent communications based on a single verified communication.

Modifying a communication may comprise encoding the authentication sequence into the information identifying the communicating party. The described method may be used to provide a factor in a multi-factorial authentication method.

According to at least one aspect described herein, there is provided a method of verifying the identity of a communicating party at a user device, the method comprising the steps of: receiving a verification signal from a communicating party at a user device, wherein the verification signal specifies one or more conditions relating to a communication from the communicating party; receiving a communication at the user device, wherein the communication comprises information identifying the communicating party; and determining whether the communication satisfies the specified one or more conditions thereby to verify the identity of the communicating party.

Providing a verification signal allows communications to be securely verified.

The verification signal may be a priming signal and at least one of the conditions may relate to a forthcoming communication. At least one of the conditions may specify a time of a communication. At least one of the conditions may relate to whether the communication is received within a predetermined time period. A start time may be provided for the predetermined time period. Alternatively, the predetermined time period may commence upon receipt of the priming signal. The predetermined time period may be a repeating time period.

Determining whether the communication satisfies the at least one condition may comprise checking an internal clock of a user device. Alternatively, determining whether the communication satisfies the at least one condition may comprise checking a timestamp of the communication.

At least one of the conditions may relate to whether the communication is the next communication comprising information identifying the communicating party.

The verification signal may comprise a message indicating the one or more conditions to the user.

The verification signal may be received in response to a confirmatory communication, wherein the confirmatory communication is transmitted from the user device after the communication is received at the user device. The confirmatory communication may be a communication to the communicating party identified in the received communication. Alternatively, the confirmatory communication may be a communication to a third party.

At least one of the conditions may relate to whether the communicating party issued the communication. At least one of the conditions may relate to metadata associated with the device from which the communication issued. The metadata may include one or more of: a device location; data from a finger print scanner; and a password entered by the communicating party at the device.

The communication may be a telephone call and the information identifying the communicating party may be caller ID information. The method may comprise the further step of displaying whether the identity of the communicating party has been verified on an incoming call screen of the user device.

Alternatively, the communication may be one of: an email, an instant message, a text message, a video message, and an audio message.

The method may comprise the further steps of verifying the identity of the communicating party in relation to subsequent communications based on a single verified communication; and saving the one or more conditions into local data storage on the user device. Saving the one or more conditions may comprise overwriting any previously saved one or more conditions.

The method may comprise the further steps of blocking the communication upon determining that the communication does not satisfy the one or more conditions; and indicating whether the identity of the communicating party has been verified to a user. Indicating whether the identity of the communicating party has been verified may comprise displaying a message. The message may comprise an item of media content.

The method may comprise the further step of detecting a user interaction with the user device in response to the item of media content; and transmitting information relating to the user interaction to the communicating party. The information relating to the user interaction may comprise one or more of: a communication, a schedule for a further communication, a selection of an option, and/or a request for a further communication via an alternative communication medium.

Indicating whether the identity of the communicating party has been verified may comprise playing an audio clip.

The method may comprise the further steps of saving information relating to the communication and whether the identity of the communicating party was verified in relation to said communication to a database on the user device; and transmitting the contents of the database to the communicating party.

The communicating party may communicate with the user device using a further user device. The user device may be one of: a smartphone, a laptop computer, a desktop computer, or a tablet computer.

According to at least one aspect described herein, there is provided apparatus for verifying the identity of a communicating party at a user device, comprising: a module for receiving a communication at the user device, wherein the communication comprises information identifying the communicating party; and a module for determining whether the information identifying the communicating party comprises an authentication sequence indicative of the identity of the communicating party; a module for comparing the authentication sequence against at least one pre-determined criteria to determine whether the authentication sequence is valid, thereby to verify the identity of the communicating party. The apparatus may further comprise an indication module for indicating whether the identity of the communicating party has been verified to a user.

Optionally, the authentication sequence may be a variable authentication sequence.

According to at least one aspect described herein, there is provided apparatus for verifiably communicating with a user device, comprising: a module for generating an authentication sequence for incorporation into a communication; a module for modifying a communication, wherein the communication comprises information identifying the communicating party and wherein the module for modifying a communication is operable to modify the information to incorporate the authentication sequence; and a module for transmitting the modified communication to the user device.

According to at least one aspect described herein, there is provided a system for verifying the identity of a communicating party at a user device; comprising: apparatus for verifying the identity of a communicating party at a user device as described herein; and apparatus for verifiably communicating with a user device as described herein. The communication may be a telephone call and the information identifying the communicating party may be caller ID information.

According to at least one aspect described herein, there is provided apparatus for verifying the identity of a communicating party at a user device; comprising: a module for receiving a verification signal from a communicating party at a user device, wherein the verification signal specifies one or more conditions relating to a communication from the communicating party; a module for receiving a communication at the user device, wherein the communication comprises information identifying the communicating party; and a module for determining whether the communication satisfies the specified one or more conditions thereby to verify the identity of the communicating party. The apparatus may further comprise an indication module for indicating whether the identity of the communicating party has been verified to a user.

According to at least one aspect described herein, there is provided a system for verifying the identity of a communicating party at a user device; comprising: apparatus as described herein; a communication apparatus for sending a priming signal; and a communication apparatus for sending a communication.

The invention extends to methods, system and apparatus substantially as herein described and/or as illustrated with reference to the accompanying figures.

The invention also provides a computer program or a computer program product for carrying out any of the methods described herein, and/or for embodying any of the apparatus features described herein, and a computer readable medium having stored thereon a program for carrying out any of the methods described herein and/or for embodying any of the apparatus features described herein.

The invention also provides a signal embodying a computer program or a computer program product for carrying out any of the methods described herein, and/or for embodying any of the apparatus features described herein, a method of transmitting such a signal, and a computer product having an operating system which supports a computer program for carrying out the methods described herein and/or for embodying any of the apparatus features described herein.

Any feature in one aspect of the invention may be applied to other aspects of the invention, in any appropriate combination. In particular, method aspects may be applied to apparatus aspects, and vice versa. As used herein, means plus function features may be expressed alternatively in terms of their corresponding structure, such as a suitably programmed processor and associated memory.

Furthermore, features implanted in hardware may generally be implemented in software, and vice versa. Any reference to software and hardware features herein should be construed accordingly.

Any feature in one aspect of the invention may be applied to other aspects of the invention, in any appropriate combination. In particular, method aspects may be applied apparatus aspects, and vice versa. As used herein, means plus function features may be expressed alternatively in terms of their corresponding structure, such as a suitably programmed processor and associated memory.

As used herein, references to time preferably connote a time of day (for a local time zone) on a particular date.

As used herein, the terms ‘telephone call’, ‘phone call’, and ‘call’ preferably connote telecommunications using landline telephone networks, mobile telephone networks, and/or voice over Internet Protocol (VoIP) systems.

As used herein, the term ‘factors’ may also connote ‘parameters’.

Furthermore, features implemented in hardware may generally be implemented in software, and vice versa. Any reference to software and hardware features herein should be construed accordingly.

Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

### BRIEF DESCRIPTION OF THE SEVERAL VIEWS OF THE DRAWINGS

The invention will now be described, purely by way of example, with reference to the accompanying drawings, in which:

FIG. 1 shows an overview of a communication verification system;

FIG. 2 shows a schematic diagram of a client device;

FIG. 3 shows a schematic diagram of the inputs and outputs to an app provided on the client device;

FIG. 4 shows a schematic diagram of the software modules of the app suitable for use in a verification method based on the use of a priming signal;

FIG. 5 shows a flow chart of a verification method for a communication being based on the use of a priming signal;

FIG. 6 shows a schematic diagram of the software modules of a communication apparatus suitable for use in a verification method based on an authentication sequence;

FIG. 7 shows a schematic diagram of the software modules of an app suitable for use in a verification method based on an authentication sequence;

FIG. 8 shows a flow chart of a verification method for a communication being based on an authentication sequence;

FIG. 9 shows an example of a communication verification system with a third party;

FIG. 10 shows an example of an item of media content for display for a ‘verified’ telephone call; and

FIG. 11 shows an example of an item of media content for display for an ‘unverified’ telephone call.

### DESCRIPTION OF SPECIFIC EMBODIMENTS OF THE INVENTION

### System Overview and Priming

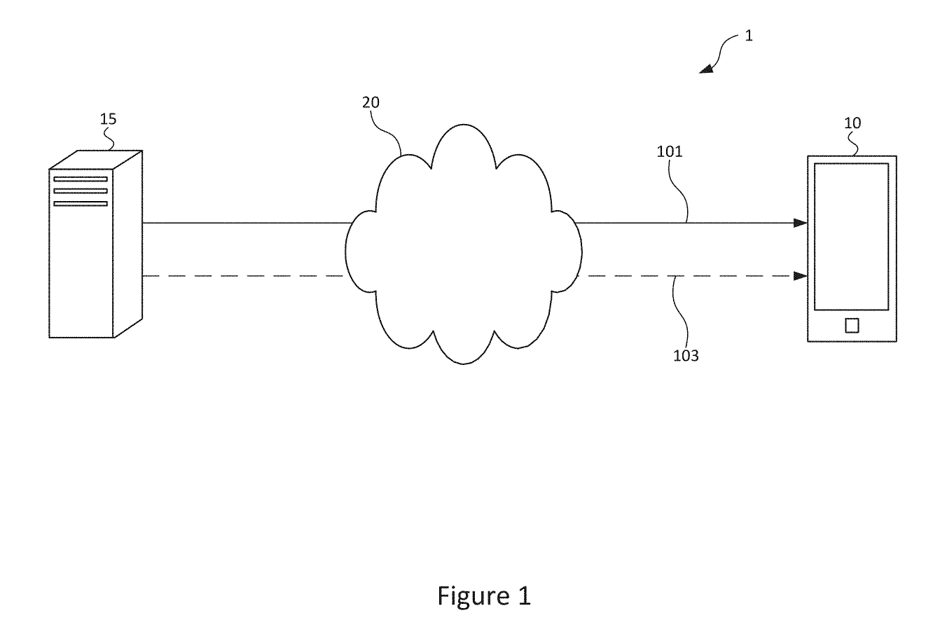

FIG. 1 shows an overview of a communication verification system 1. A client device 10, comprising for example a telephone handset—such as a smartphone—is adapted to receive communications 101 from a communicating party (who may be referred to as a ‘provider’) using communication apparatus 15, over a communications network 20. The client device 10 may alternatively be any other device capable of accessing network 20, such as a desktop, laptop, or tablet computer.

Network 20 is one of an IP-based network, a 3G (or higher) telecommunications network or a combination of different types of communications networks, which may include landline and/or mobile telephone network and the internet.

The communication apparatus 15 is, in a simple example, another client device 10. Alternatively, the communication apparatus 15 is a call centre arranged to make outbound calls and/or communications using other media to client devices 10.

The communication apparatus 15 is arranged to transmit a signal 103 to the client device 10 via network 20. The signal 103 comprises scheduling information for an upcoming communication, such as a telephone call, from the communication apparatus 15 to the client device 10. Such a signal 103 may be referred to as a ‘priming signal’ 103. Communications 101 received at the client device 100 are verified only when a particular communication 101 matches the scheduling information provided in the priming signal.

The scheduling information comprises a particular time or upcoming time period within which the communication 101 will be instigated (for example, the priming signal 103 can provide the information “a telephone call will be made between 3 pm and 5 pm on 13^{th} July”). The scheduling information is set by the provider. The client device 10 is configured to perform an action in accordance with the priming signal 103, as will be described later on. In an alternative example, the priming signal 103 is sent by the provider using other means, for example a remote media server operable to communicate with the client device 10 over network 20.

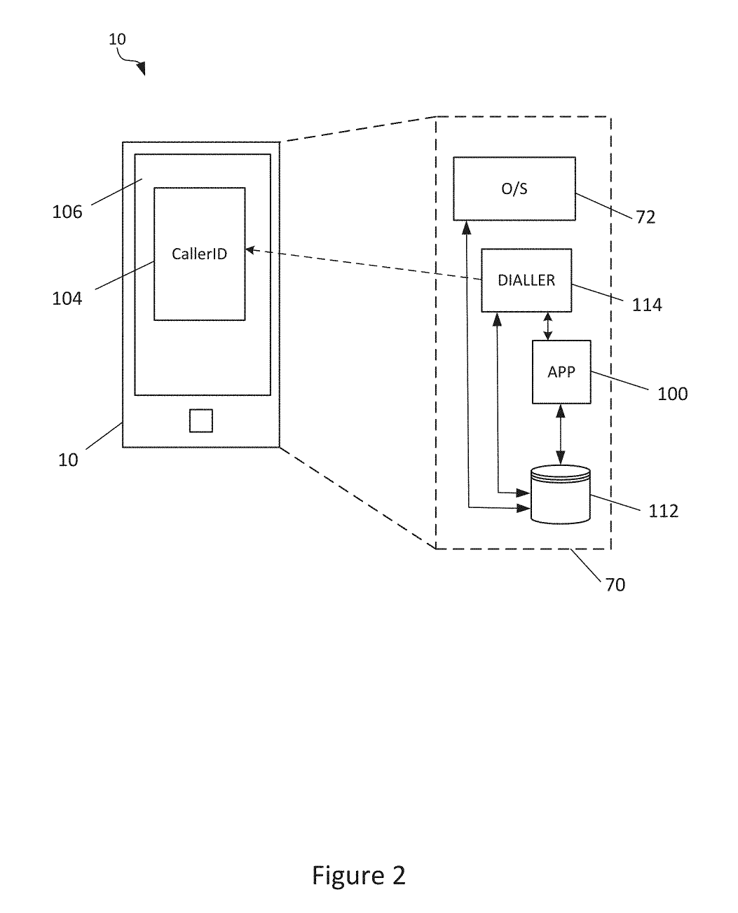

FIG. 2 shows a schematic diagram of a client device 10. The client device 10 comprises a display screen 106 on which information related to the identity of a communicating party 104 is displayed when the client device 10 receives an incoming communication from the communicating party. In the example of an incoming telephone call, the information 104 is caller ID information 104. Also shown are example contents of the system memory or software architecture 70 of the client device 10 when in operation, showing the operating system (OS) 72, the “dialer” application 114 which handles the making and receiving of telephone calls, and telephone call verification application (commonly referred to as an “app”) 100. A data store 112 is shared by the operating system 72 and software applications installed on the client device 10. The client device is also provided with a processor (not shown).

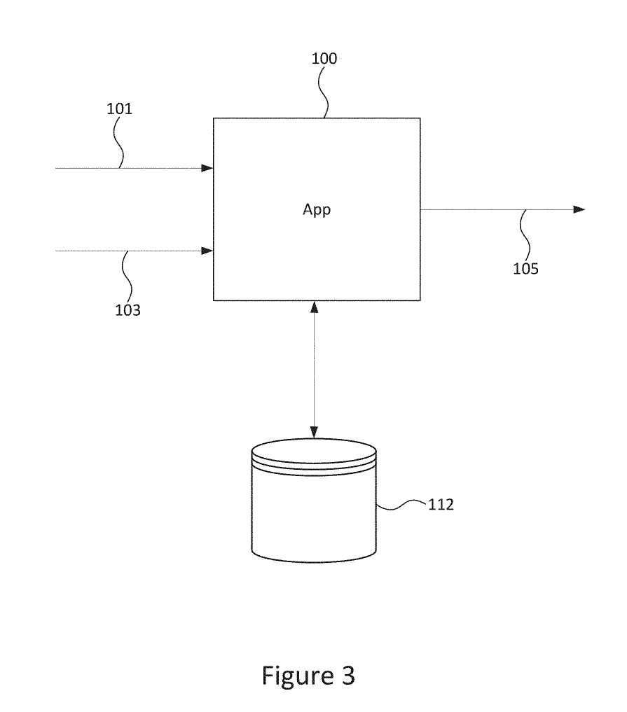

FIG. 3 shows a schematic diagram of the inputs and outputs to the app 100. The app 100 is preferably associated with the provider, and in an example implementation is provided as part of a further app associated with the provider. In an example, the further app is a mobile banking app. Providing the app 100 as part of a further app may provide an incentive for a user to accept the app 100 on the client device 100.

The app 100 is arranged to receive the priming signal 103 and the communication 101. In a variant, the app 100 receives indications that represent the priming signal 103 and the communication 101 from other components of the client device 100 (for example, the dialer 114). The app 100 is provided in communication with the data store 112, and both sends and receives data from said data store 112. The app 100 is arranged to output an indication 105 of verification.

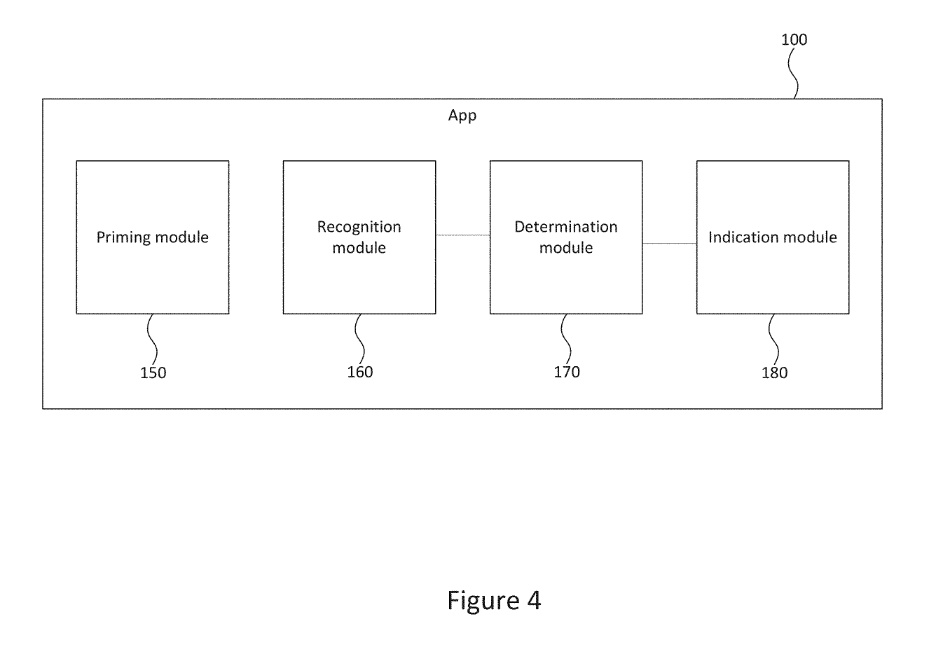

FIG. 4 shows a schematic diagram of the software modules of the app 100. The app 100 comprises a priming module 150, a recognition module 160, a determination module 170, and an indication module 180.

The priming module 150 is arranged to receive the priming signal 103 (for example, via a radio component of the client device 10). The priming module 103 is arranged to interpret the scheduling information provided by the priming signal 103 and store the scheduling information into the data store 112.

The recognition module 160 is arranged to receive a communication 101 and/or an indication that a communication 101 has been received (for example, via the dialer 114). The recognition module is arranged to detect whether the communication purportedly originates from the provider. For a telephone call, this is detected by checking the received caller ID information 104 against saved caller ID information 104 for the communication apparatus 15. In an example, saved caller ID information 104 is stored in the data store 112. In a variant, the recognition module 160 queries an address book of the client device 100. Optionally, the recognition module 160 may be arranged to monitor caller ID information 104 relating to several parties, such as various different departments within a company. The recognition module is provided in communication with the determination module 170, and is arranged to activate the determination module 170 when a communication purportedly originating from the provider is received.

The determination module 170 is arranged to determine whether the communication 101 detected by the recognition module should be verified by comparing the properties of the communication 101 (for example, the time at which the communication 101 is instigated at the telephone apparatus 15 or is received at the client device 100) against the saved scheduling information in the data store 112. The determination module 170 is capable of producing a verification status for a particular communication 101. If the communication matches the scheduling information, the communication 101 is verified. If there is no match, the communication 101 is unverified. The determination module 170 is provided in communication with the indication module 180 such that the verification status of a particular communication 101 is communicated to the indication module 180. Optionally, a record of all communications 101 and their verification statuses may be saved into the data store 112.

The indication module 180 is arranged to indicate the verification status of a particular communication 101 to a user. The indication module 180 is arranged to control a screen and/or loudspeaker of the client device in order to indicate the verification status, and is provided in communication with the data store 112. The functions of the indication module 180 will be described in more detail later on.

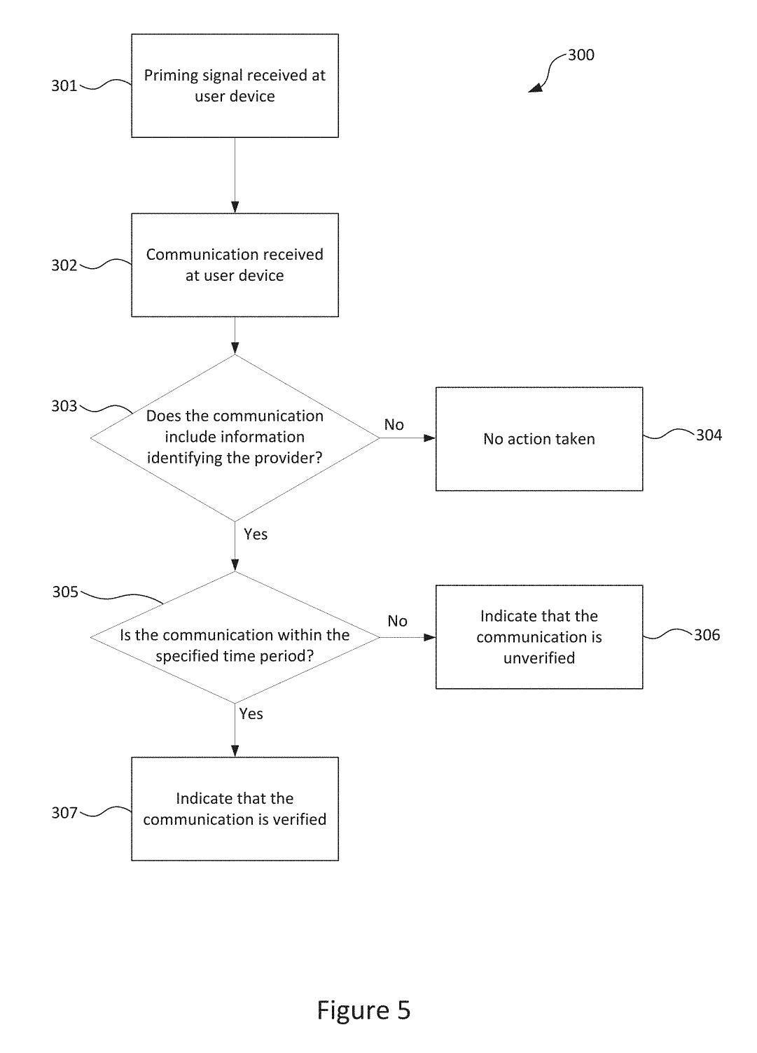

FIG. 5 shows a flow chart of a verification method 300 for a communication involving the use of a priming signal. The method 300 is implemented at the client device 10, using the app 100 and the processor of the client device 10. In step 301, the priming signal 103 comprising scheduling information is received from a communication apparatus 15, as described above.

In step 302, a communication 101 is received at the client device 10. The communication 101 is associated with information identifying the communicating party 104 (such as caller ID information for a telephone call or an email address for an email), which is received at the client device 10 along with the communication. The app 100 receives notice that the communication is received using the recognition module 160.

In step 303, the client device 10 is arranged to determine whether the information identifying the communicating party 104 identifies the provider and/or communication apparatus 15 using the recognition module 160. If the information identifying the communicating party 104 is unrecognised, no further action is taken (step 304) and the client device rings as normal. If the information identifying the communicating party 104 is recognised as being associated with the communication apparatus 15 and/or the provider, the communicating party is either the provider or a ‘spoofer’ attempting to impersonate the provider. Further verification steps are needed to determine whether the communication 101 is genuinely from the party identified by the information 104.

If the information identifying the communicating party is recognised as being associated with the communication apparatus 15 and/or provider, the app 100 is arranged to compare the current time against the stored scheduling information provided as part of the priming signal 103 (step 305) using determination module 170. If the current time matches the time at which the communication 101 was scheduled in the scheduling information, this indicates that the communication 101 is genuinely from the communication apparatus 15 (except for the rare circumstance where a spoof communication is made at the scheduled time). In this case, the user is then informed that the communication 101 is verified via an indication 105 using indication module 180 (step 306). If the current time does not match the time at which the communication 101 was scheduled in the scheduling information, the communication 101 cannot be verified as being from the communication apparatus 15. The user is then informed that the communication 101 is unverified via an indication 105 using indication module 180 (step 307).

The described process is arranged to take place over a short time period following the communication 101 being received at the client device 10. For a telephone call 101, the indication 105 that the call 101 is ‘verified’ or ‘unverified’ is presented to the user as or very shortly after the call 101 starts to ring. The indication 105 is preferably displayed on an incoming call screen, as will be described later on.

A similar verification process is followed where no priming signal 103 is received. However, since no scheduling information will be available to the app 100, any communication 101 received will in this case always be marked as ‘unverified’.

The current time is determined with reference to an internal clock of the client device 100, or is alternatively set by an external signal. In an example, the external signal is the communication 101 itself, where the time at which the communication 101 is instigated at the telephone apparatus 15 or is received at the client device 100 is provided as part of or alongside the information related to the identity of the communicating party 104.

The scheduling information preferably comprises a time period rather than a specific time so as to mitigate the effects of any difference between the detected times at the communication apparatus 15 and the client device 10. Providing a time period also allows for flexibility in the time at which a ‘verified’ communication 101 is made from the communication apparatus 15, which may be useful for a provider who makes many outbound communications to many client devices 10. The length of the time period is set by the provider; preferably, the length of the time period is as short as possible to mitigate the (small) possibility that a spoof communication is made to the client device 100 within the time period. However, a very short time period may result in circumstances where a communication 101 which was intended to be marked as verified is received outside of the time period and so is marked as ‘unverified’ (for example, where the communication apparatus 15 is part of a call centre where a delay occurs). As such, a balance must be made in setting the length of the time period. Optionally, the portion of the data store 112 containing the saved scheduling information may be cleared following the expiry of the time period.

The scheduling information defines a one-off time or time period for verifying communications 101, or alternatively defines a repeating time or time period. For example, the app 100 could be arranged to verify all communications 101 having information 104 associated with the communication apparatus 15 within 10 minutes of 12 pm every Monday. In such a case where a repeating time period is used, the scheduling information is updated intermittently via a new priming signal 103 to mitigate the possibility of malicious parties becoming privy to this information.

Where a further priming signal 103 is received at the client device 10, the scheduled information contained in the further priming signal 103 overwrites and replaces the schedule information in the data store 112. In this way, further priming signals 103 is used to cancel or extend any time periods defined by stored schedule information.

The length of time separating the priming signal 103 being received at the client device 100 and the communication 101 being received at the client device 100 is large (for example, several weeks) or small (for example, a few seconds). In an example, the priming signal 103 is received immediately before a communication 101 is received. In such an example, the priming signal 103 schedules an end to a time period which begins immediately as the priming signal 103 is received (for example, the priming signal 103 provides the information “verify all calls from this telephone number in the next two hours”). This is particularly useful where, for example, the user of the client device 100 has an immediate issue and needs to be contacted several times over a short period of time.

The priming signal 103 is hidden from the user, or alternatively is visible. For example, the receipt of the priming signal 103 could cause the app 100 to display a notification on a screen of the client device 10 indicating when the user should expect a communication 101. In a further example, the priming signal 103 itself is a visible message to the user (transmitted via SMS or email, for example) indicating when the user should expect a communication 101, which the app 100 is configured to recognise as a priming signal 103 comprising scheduling information.

The security of the verification system 1 relies on the fact that a ‘spoofer’ is unable to send a genuine priming signal 103. A variety of authentication protocols is included in the priming signal 103 to ensure that the signal cannot be faked. For example, the priming signal 103 comprises a number string forming a unique key which is recognised by the priming module 150, where the priming signal 103 is not accepted without this unique key. Optionally, a cryptographic hash may be used at the communication apparatus 15 and the client device 10 to improve security.

In some circumstances, the provider may need to contact the user on an unscheduled basis. In such an example, the priming signal 103 is provided at the same time as the communication is received, in which case the communication is verified as normal. In a further alternative, the priming signal is received after the communication has been received, while the communication is ongoing (for example, when a call is ringing) at the user device 100. In this case, the app 100 is arranged to verify the communication as soon as the priming signal 103 is received, provided that the priming signal 103 schedules that a time period for verification begins immediately. The app 100 is arranged to change the indication to the user that the communication is unverified to an indication that the communication is now verified. The priming signal 103 is the same signal carrying the same information as previously described, or comprises further information which is required by the app 100 in order for the communication to be verified. This assists in mitigating the greater risk of spoofing involved in unscheduled communications. In an example, the priming signal 103 comprises a further unique ID, which is hashed. This further unique ID is required for the priming signal 103 to be recognised. The unique ID is associated with the properties of the particular communication itself to improve security. For example, the unique ID may comprise a timestamp which is associated with the communication.

In an alternative, rather than specifying a time or time period when communications should be verified, the scheduling information provided in the priming signal 103 simply specifies that the next communication with information related to the identity of the provider and/or the communication apparatus 15) should be verified. This is particularly useful when there is only a short time between the priming signal 103 being received and the communication 101 being received at the client device 10. In such a case, the cache containing the saved scheduling information is cleared following a communication being verified, to prevent any subsequent communications being accidentally verified. The cache is cleared after a predetermined period of time in which no communication is received (for example due to an error by the provider), to prevent any later spoof communications being accidentally verified.

### Authentication Sequence

The system 1 and app 100 can also be used for other verification methods. Verification methods can be combined with a method using a priming signal as described above, or can take the place of the priming method. These alternatives can be advantageous compared to the priming method as they can avoid the requirement of advance planning prior to a communication. They can also provide better protection against a ‘spoofer’ adapting the priming method to obtain false authentication.

In an example of an additional/alternative verification method, the app 100 is adapted to confirm the identity of the provider by recognising a variable authentication sequence incorporated into the information related to the identity of the provider 104. The authentication sequence is known (or can be determined with reference to one or more parameters) by the communication apparatus 15 and the user device 10, but is not known and cannot be determined by any intercepting third parties. Detected authentication sequences are compared against at least one criteria to determine whether the authentication sequences are valid and hence whether the communication should be verified.

The authentication sequence is a sequence of numbers, letters, or symbols generated by the communication apparatus 15. An authentication sequence for a given communicating party (such as the provider) may be arranged to vary between different communications and/or between different user devices, for example, such that the authentication sequence is not a constant identifier of the identity of the communicating party. In an example, the authentication sequence is arranged to vary based on one or more parameters, as will be described later on. The information related to the identity of the provider 104 is caller ID information in the case of a telephone call, so the authentication sequence takes the form of a variable sequence of numbers. The authentication sequence may also be included in a user name, identifying address, or any other information related to the identity of a communicating party 104.

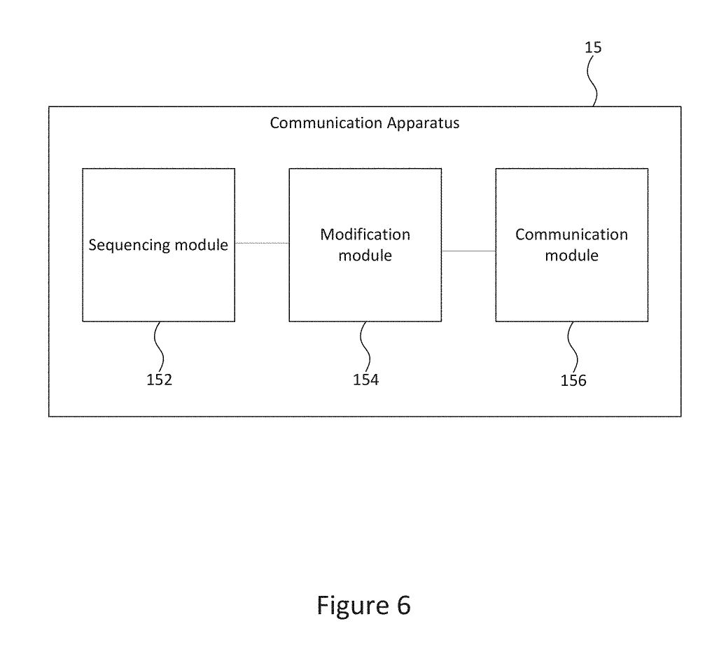

FIG. 6 shows a schematic diagram of the software modules of a communication apparatus 15 suitable for use in a verification method based on an authentication sequence. The communication apparatus 15 comprises a sequencing module 152, a modification module 154, and a communication module 156.

The sequencing module 152 is arranged to generate a suitable authentication sequence. The authentication sequence can be generated in various ways, as will be described later on. The sequencing module 152 is provided in communication with the modification module 154 so as to communicate the authentication sequence to the modification module 154.

The modification module 154 is arranged to cause a communication 101 to assume artificial information identifying the communicating party 104, where this information incorporates the authentication sequence. In the case of a telephone call, this is provided in an example by spoofing the caller ID information 104 to a sequence incorporating the authentication sequence. The modification module is arranged to communicate with the communication module 156 to pass on the artificial information identifying the communicating party 104.

The communication module 156 is arranged to interface with a transmitter component of the communication apparatus to transmit a communication to the user device 10.

Where the communication apparatus 15 is used in a telephone call 15, the method by which the artificial caller ID information 104 is assumed depends on the type of telephone call. For a VoIP telephone call, the caller ID information 104 can be manipulated directly. For other analogue and digital telephone systems, a proprietary ‘caller ID spoofing’ system provided by a third party can be used. In this case, the modification module 154 is arranged to forward the telephone number to be called and the desired caller ID information 104 to the third party. Where a third party ‘caller ID spoofing’ system is used, the communication module 156 is omitted from the communication apparatus 15, since the communication 101 will be routed via the third party.

Any number of digits can be used for the assumed artificial caller ID information 104. The use of more digits allows for a wider range of authentication sequences to be used, however, a user may be more distrustful (and so less likely to answer a telephone call) of caller ID information that is obviously too long to be a valid telephone number. The assumed artificial caller ID information 104 is adapted so as to follow a regional phone number convention. For example, the assumed artificial caller ID information 104 can be selected to start with the numbers 0800; this helps avoid user confusion in case the user's phone does not have the app available for caller verification (for example, if the user receives the call using a landline system with caller ID functionality). The assumed artificial caller ID information 104 can be arranged to look like a valid format to mitigate user confusion—for example, the caller ID may show ‘02028994449’, which looks innocuous but has one digit too many to be a valid telephone number. Preferably, valid telephone number formats are not used in the assumed artificial caller ID information 104, so as to prevent any party using the telephone number shown in the caller ID information from being contacted by a user attempting to call the provider. In an example, the authentication code is composed in only certain of the digits of the assumed artificial caller ID information 104, which can be adjacent digits or non-adjacent digits.

In a variant for use when the communication apparatus 15 is used in telephone calls, the caller ID information 104 for the telephone call 101 is selected by calling the client device 10 from one of a plurality of telephone numbers that are available to the provider, rather than by assuming artificial caller ID information 104. For example, the provider may own or switch partition a range of telephone numbers. The provider calls from different telephone numbers in the available range to provide different authentication sequences to the user device. The authentication sequence is provided by the differences in the digits between the range of telephone numbers. For example, where the calling party can use the range 0800444xxxx (where ‘xxxx’ represents any combination of digits), the last four digits of the telephone number used provide the authentication sequence. Using a range of telephone numbers is particularly useful where the provider does not know if the user device 10 is provided with the app 100 (due to incomplete records, for example), as the user is more likely to be willing to receive calls from telephone number associated with valid caller IDs.

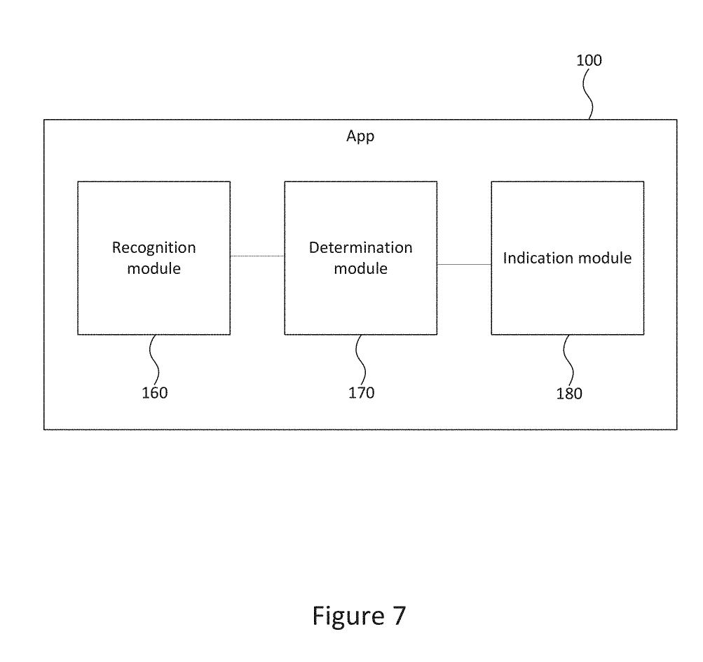

FIG. 7 shows a schematic diagram of the software modules of an app 100 suitable for use in a verification method based on an authentication sequence. The app 100 comprises a recognition module 160, a determination module 160, and an indication module 180. The app 100 can be the same as the previously described app, in which the modules are adapted to perform additional functions.

As previously described, the recognition module 160 is arranged to receive a communication 101 and/or an indication that a communication 101 has been received (for example, via the dialer 114). The recognition module 160 is provided in communication with the determination module 170 so as to communicate information identifying the communicating party 104 to the determination module.

The determination module 170 is operable to detect the presence of an authentication sequence incorporated into the information identifying the communicating party 104 and to determine whether the authentication sequence is valid, thereby to determine if the communication should be verified. The determination module 170 is arranged to determine whether an authentication sequence is valid by comparing the authentication sequence against at least one predetermined criteria. The determination module 170 is capable of producing a verification status for a particular communication 101 accordingly. The determination module 170 is provided in communication with the indication module 180 such that the verification status of a particular communication 101 is communicated to the indication module 180. Optionally, a record of all communications 101 and their verification statuses is saved into the data store 112.

As previously described, the indication module 180 is arranged to indicate the verification status of a particular communication 101 to a user.

It will be appreciated that there is no need to provide a priming module 150 since the information allowing verification to take place is provided in a communication 101 and in the criteria provided in the determination module 170, rather than in a priming signal.

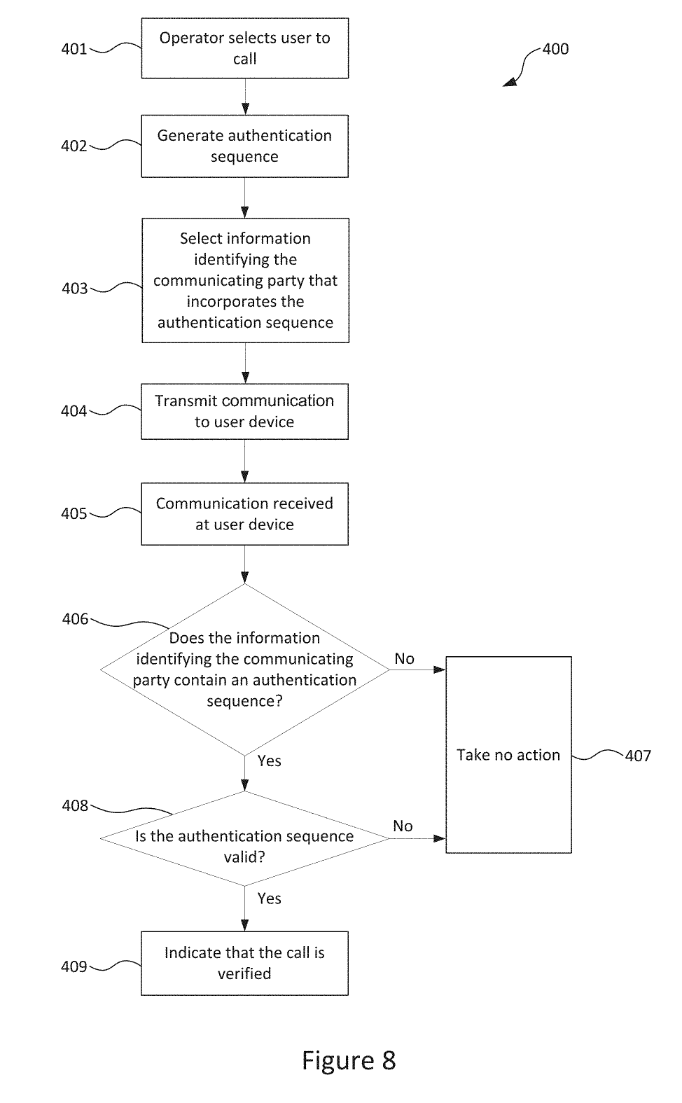

FIG. 8 shows a flow chart of a verification method 400 for a communication 101 involving an authentication sequence. In step 401, an operator of the communication apparatus 15 selects a client device 10 to be communicated with, where the client device 10 is provided with the app 100.

In step 402, an authentication sequence is generated using sequencing module 152. In step 403, the communication apparatus 15 selects information identifying the communicating party 104 for the communication 101 which incorporates the authentication sequence using modification module 154 or by selecting the telephone number to use, as described. In step 404, the communication 101 is made from the communication apparatus 15 to the user device 10 using the communication module 156 and a transmitter component of the communication apparatus 15.

In step 405, the communication 101 is received at the client device 10, which is detected by the recognition module 160. In step 406, the client device 100 is arranged to determine whether the information identifying the communicating party 104 contains an authentication sequence using the determination module 170. It will be appreciated that since the information identifying the communicating party 104 is selected to incorporate the authentication sequence, the information 104 does not directly identify the provider and/or the communication apparatus 15 so there is no need to incorporate an equivalent step to step 303 in the previously described verification method 300.

If no authentication sequence is detected, no further action is taken (step 407) and the client device receives the communication as normal. If an authentication sequence is detected by the determination module, the validity of the authentication sequence is determined using the determination module (step 408). If the detected authentication sequence is invalid, no action is taken (step 407). If a valid authentication sequence is detected, this indicates that the communication 101 is genuinely from the communication apparatus 15. In this case, the user is then informed that the communication 101 is verified via an indication 105 using indication module 180 (step 306).

As described with reference to the verification method 300, the verification method 400 is arranged to be performed over a short time period following the communication 101 being received at the client device 10. For a telephone call, the indication 105 that the telephone call 101 is ‘verified’ or ‘unverified’ is presented to the user as or very shortly after the call starts to ring. The indication 105 is preferably displayed on an incoming call screen, as will be described later on.

The criteria for validity provided in the determination module include whether the detected authentication sequence is present on a list of possible valid authentication sequences. The list is stored in the data store 112, with which the determination module 170 is arranged to communicate.

The authentication sequence is generated using an algorithm provided at the communication apparatus 15. The determination module 170 is arranged to detect valid outputs of the algorithm, so ‘spoofers’ are unable to produce verifiable communications unless they have access to the algorithm.

To improve security, the algorithm can generate an authentication sequence that is specific to a particular user. For example, the authentication sequence can be made up of a first group of numbers or letters which can be a sender identifier, and a second group of numbers or letters which can be a receiver identifier. If an incoming communication is received that purports to be from the provider and gives as information identifying the communicating party the telephone number or email address of the provider, then the app can treat the communication as likely fraudulent. For a telephone call, although a single static number is still associated with the authentic caller much as in the case of a conventional caller ID indicating a caller number, the number is specific to the user and the caller, and it is less easy for a spoof caller to determine which number to use. The entire group of numbers can be a receiver identifier.

The authentication sequence can be generated in dependence on one or more parameters related to the user or the user device. Such parameters include an app user identification number, a user telephone IMEI (International Mobile Equipment Identity) number, a user telephone number, or a secret key that is specific to a user account associated with the app 100. The parameters are determined or stored independently at the communication apparatus 15 and at the client device 10 so as to allow the communication apparatus 15 and client device 10 to generate and determine the validity of the authentication sequence independently.

To further improve security, the authentication sequence can be generated based on one or more dynamic parameters. The one or more dynamic parameters are used alternatively or in addition to the one or more parameters related to the user or the user device 10. Possible dynamic parameters include the time of day, the day of week, or the date. The algorithm can determine a suitable authentication sequence in dependence on the parameter.

Where one or more dynamic parameters are used, the possible valid authentication sequences provided on the list accessible to the determination module 170 depend on the value of the parameter. The list specifies which authentication sequences are valid in dependence of the value of the parameter—for example, the list can specify that ‘authentication code 1234 is valid between 10 am and 11 am on a Tuesday’. The determination module 170 is able to determine the state of the one or more dynamic parameters independently from the communication. For example, where the dynamic parameter relates to time, the determination module 170 consults an internal clock of the user device 10.

Generating an authentication sequence based on one or more dynamic parameters limits the risk of damage if a correct authentication sequence is obtained for malicious use to the time window where that sequence is valid.

In a variant, the determination module 170 is provided with a further algorithm being arranged to calculate whether the detected authentication sequence is valid, as an alternative or an addition to the described list of valid results. The further algorithm can also be arranged to calculate an inverse function of the algorithm in order to determine whether the authentication sequence is valid. The further algorithm is arranged to receive the same parameters as the algorithm used to generate the authentication sequence. These parameters are measured independently, as previously described. For some examples of algorithms, it is possible to provide the same algorithm at the determination module 170 and the communication apparatus 15, with each algorithm being able to recognise the sequences generated by the other algorithm. Where the same algorithm is used, the determination module 170 is operable to use the algorithm to determine the validity of authentication sequences generated by the algorithm at the communication apparatus 15. The use of a further algorithm allows for more variables to be used in generating the authentication sequence.

The determination module 170 receives intermittent updates (via software updates, for example) in order to match any updates made to the algorithm. The algorithm may be updated dynamically, for example to increase security where malicious activity is recorded. Where a further algorithm is used, the further algorithm is governed by the algorithm, such that updates to the algorithm are transmitted to the further algorithm to coordinate the algorithm and the further algorithm.

Optionally, the authentication sequence is coded or hashed so as to improve security. In an example, both the algorithm and the further algorithm are arranged to encode and decode the hash. In such a case, the authentication sequence is encoded into the information related to the identity of a communicating party.

In a variant, the authentication sequence is generated at the user device 10 (for example by the use of the further algorithm) and is communicated to the communication apparatus 15. The communication apparatus 15 then incorporates the authentication sequence into communications to verify the communications, as described.

In a further variant, the authentication sequence is simply generated randomly to provide variation in the authentication sequence, and the sequence is securely communicated to the app 100, for example as part of a software update.

Optionally, any incoming communications 101 identifying the provider and/or the communication apparatus 15 but not incorporating a valid authentication sequence may be indicated to the user as ‘unverified’ using verification module 180. Alternatively, any such communications 101 may be blocked.

Optionally, the described verification method 400 is used as a factor in a multi-factorial verification method, in which the communicating party 15 also attempts to verify their identity using another communication channel, for example.

### Confirmation Methods

In a further example of an additional/alternative verification method, the app 100 is adapted to confirm the identity of a communicating party by communicating with the communicating party, such as by calling an alleged caller. The authentic caller is adapted to receive such an incoming confirmatory communication and take a particular action. For example, if a confirmatory communication is received and there is an ongoing communication to that number, then a confirmation signal is provided, e.g. when the confirmatory communication is a telephone call, the call is accepted for a certain period of time and then terminated. The communication can then be treated as verified by the app 100. If a confirmatory communication is received and there is no ongoing communication to the user device 10 then no confirmation signal is provided, e.g. any confirmatory telephone call is not accepted. The communication can then be treated as unverified by the app 100. The confirmation signal acts like an alternative priming signal, and is otherwise treated same by the app 100 as described above with reference to FIGS. 4 and 5. The app can autonomously place a confirmatory communication and provide an indication of verification. A suitable hardware or software can be used by the provider (such as a bank) to handle confirmatory communications as required.

In another example of an additional/alternative verification method, the app 100 is arranged to receive aggregated lists of information related to the identity of a communicating party 104 (such as caller ID information) that the app 100 is arranged to seek to verify. The lists are provided via the communication apparatus 15, or via a separate server.

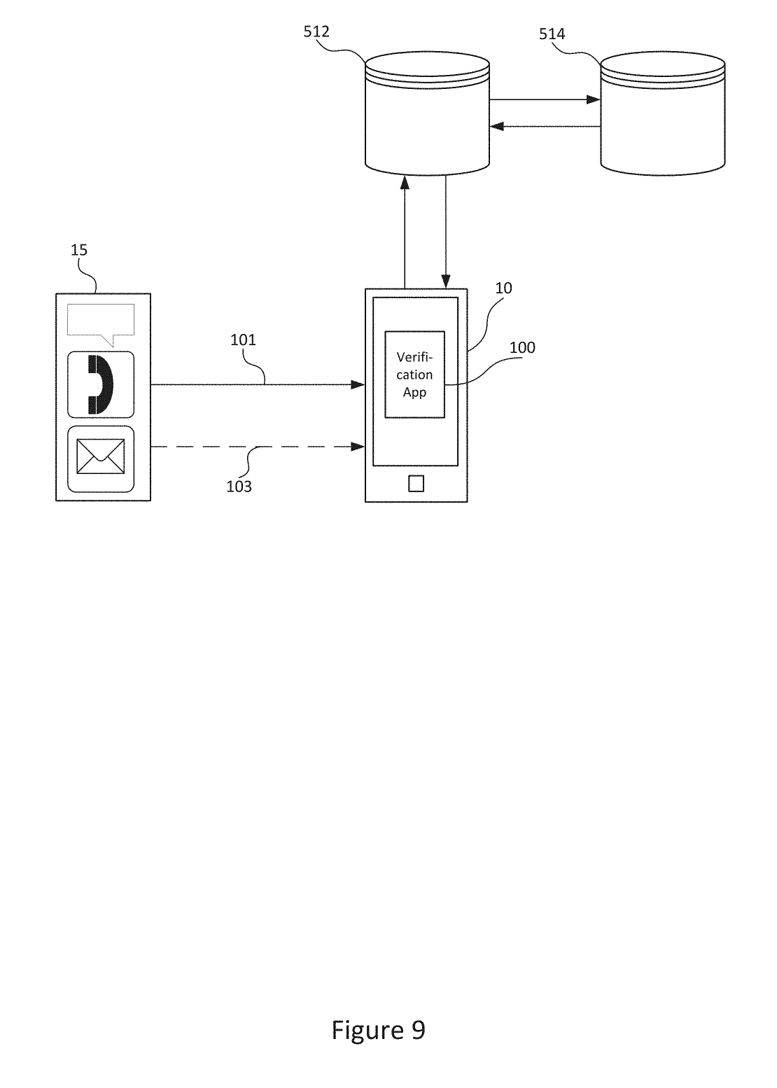

FIG. 9 shows an example where a server 512 with middleware is provided by a trusted third party; a subscriber such as a bank, with its own data stores 514, subscribes to a verification service provided by the third party. The subscriber can provide certain data to the third party to assist verification, and can also access data relating to verifications. An app 100 is provided by the subscriber to users such as banking customers to enable the users to use the verification service. The app 100 can obtain data from the server 512 of the third party (e.g. for obtaining information related to the identity of a communicating party 104, in the given example to identify a bank branch office), and the app also provides data to the third party (e.g. to check whether a communication is legitimate by additional methods). The exchange of data from the user to the third party and to the subscriber can permit reporting of suspicious activity back to the subscriber.

For example, the app 100 stores a record for each incoming call with data such as caller number, call recipient number, date and time. The record can be analysed at a later date to identify fraudulent activity. Data exchange between the different parties can be encrypted.

The third party can also provide alerts to the app 100. For example, the third party can identify an unrecognised app as potentially part of fraudulent activity, and issue a report to other subscriber apps. The third party can also manage maintenance of the verification service, and for example disable functionality of subscriber apps for a period, send correspondence or error messages to subscriber apps (for example prior to suspending the service for maintenance a notification, or a message warning that the user device may be compromised).

In an example, the app 100 is adapted to confirm the identity of a communicating party by seeking verification by a third party. In this example, when an incoming communication is received the app first determines whether the purported communicating party subscribes to a verification service. If it does, the app establishes a communication with a third party. If the communicating party is indeed the provider, then the outgoing communication at the communication apparatus 15 causes an app 100 at the user device 10 to establish a communication with the third party specifying the details of the communication, including the recipient. The third party can then verify that the provider is indeed communicating with the recipient, and provides this information to the app 100. The communication can then be treated as verified by the app. If the communication is not authentic then the third party has no record of the communication to the recipient. The third party can then permit the app 100 to treat the communication as unverified. For example in an iPhone® a push functionality (optionally a ‘silent push’ function) can enable the app to perform as described above. For example in an Android® smartphone an outgoing communication can be triggered by an incoming communication to enable the app to perform as described above.

In another example of a verification method, the app 100 is adapted to confirm the identity of a communicating party by obtaining data from the communication apparatus 15. Examples of data for this purpose include a password obtained from the provider via an interface presented to the provider, at the caller's device; data from a finger print scanner; device location data, or harvesting other data from the communication apparatus 15. Different types of data can be obtained and combined in a score for better reliability. An example where this method can be useful is for private user-to-user verification, or for a bank to verify the authenticity of a communicating party purporting to be a customer, to prevent fraudulent access to confidential information. For example in a smartphone with an Android® or iPhone® operating system these functions can be implemented without undue burden.

### Indication of Verification

The indication 105 that a communication 101 is verified or unverified is a visual indication which is arranged to appear on the incoming call screen 106 where the communication 101 is a telephone call. The visual indication 105 accompanies or alternatively replaces the caller ID information 104. In an example, the app 100 is arranged to issue a notification (or other message) which is arranged to overlay the incoming call screen 106. Alternatively or additionally, the indication 105 is an aural indication, which is played over a loudspeaker of the client device 100 in place of a ringtone.

In an example, the indication 105 is an interactive item of media content 105, which is arranged to accept an input from a user. The client device 10 then performs an action in dependence on the user input. An example method of providing a client device 10 with interactive items of media content and displaying the items of media content on an incoming call screen 106 is described in WO2016/079539, which is incorporated here by reference.

The items of media content 105 are served to the client device 10 via a separate media server, as described in WO2016/079539, preferably wherein the provider controls the media server. The client device 10 may optionally store the received media content locally for later display. Alternatively, the communication apparatus 15 can be arranged to serve the client device 10 with media content 102 from the data store 112.

The item of media content 105 which is displayed depends on whether the incoming call is determined to be ‘verified’ or ‘unverified’.

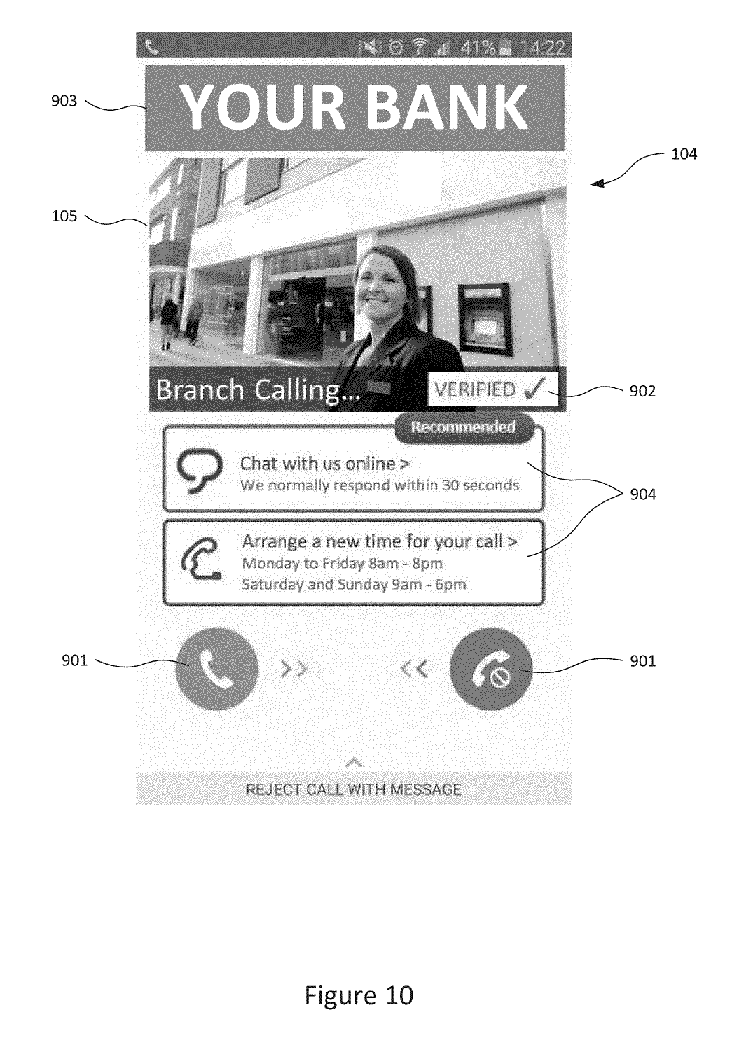

FIG. 10 shows an example of an item of media content 105 for display for a ‘verified’ telephone call. The media content item 105 is arranged to overlay most of the incoming call screen 106, such that only the call accept/reject buttons 901 (which are provided by the dialer 114) on the incoming call screen 106 are visible and accessible. The item of media content comprises a message indicating that the call is verified 902 and an identifier of the calling party 903. The media content item 105 also comprises a number of interactive buttons 904, which may be referred to as ‘feature buttons’. The buttons 901 provide hyperlinks to allow the user to access further options for interacting with the provider. For example, a button 904 can allow the user to indicate that they are unwilling or unable to take an incoming call and to specify a time at which they would like to be called back. In another example a verification score is displayed (for example: 99%). A button 904 can allow the user to provide feedback regarding the score, (for example by providing a link to a ‘help improve score’ form).

Other buttons 904 allow the user to reject the call and perform one or more of the following exemplary actions: communicate with the provider via another communication medium (such as an online chat room), call the communication apparatus 15 back, request a further inbound call, and/or request a confirmatory message (such as via SMS) that the provider is genuinely attempting to contact the user. These functions may assure the user that the call is genuine. Other possible functions of the buttons 904 are listed in WO2016/079539.

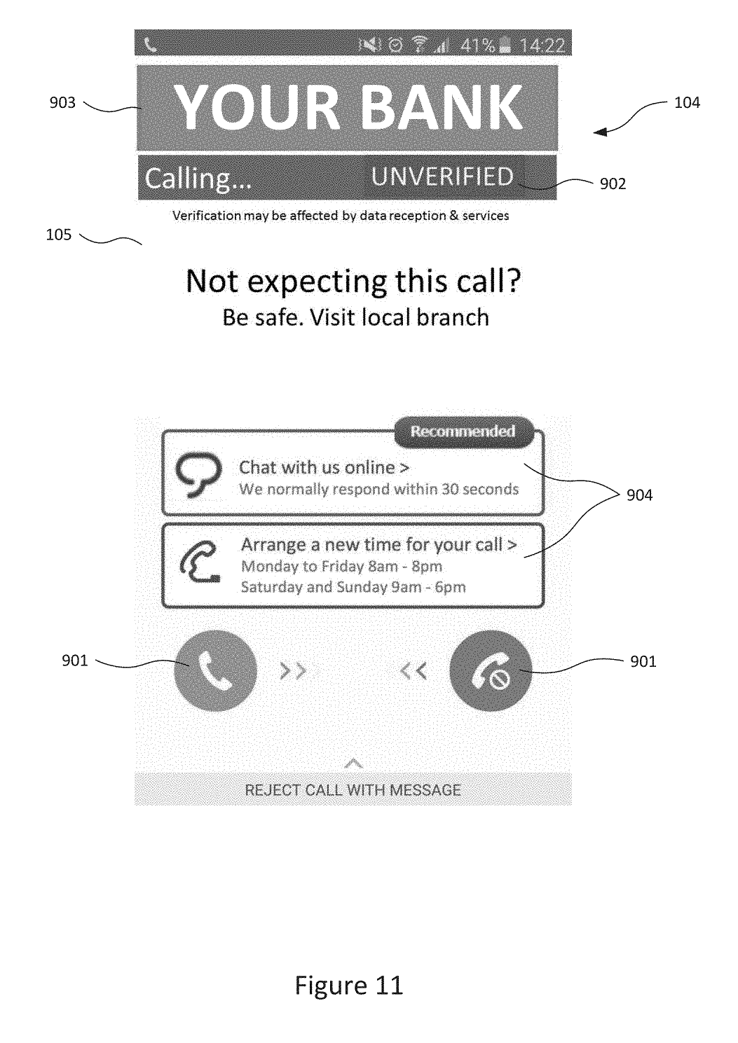

FIG. 11 shows an example of an item of media content 105 for display for an ‘unverified’ telephone call. The item of media content 105 for an unverified call is arranged in the same way as for verified calls, but comprises a message indicating that the call is unverified 902. A further message to the user can also be provided, advising as to possible further actions. The buttons 904 provided on the item of media content 105 for an ‘unverified’ call are the same as those used for a ‘verified’, or alternatively differ. In an example, the buttons 904 provided for an ‘unverified’ call allow the user to reject the call and perform one or more of the following exemplary actions: dismiss the item of media content 105, block the caller, communicate with the alleged caller via another communication medium (such as an online chat room), call the alleged caller back, request a further inbound call, and/or request a confirmatory message.

### Alternatives and Extensions

Optionally, any communications 101 marked as ‘unverified’ may be reported back to the communication apparatus 15 or the provider. In an example, the app 100 may keep a record of ‘unverified’ communications, which may include details of the time and length of the communications and whether they were answered, for example. The record may also comprise a record of verified communications 101. The record may then be transmitted to the communication apparatus 15 intermittently, for example once a month.

Optionally, the app 100 may be configured to block, monitor, or blacklist all ‘unverified’ communications having caller ID information associated with the provider.

Optionally, the app 100 may be configured to verify communications from a communicating party other than the provider. For example, a third party may coordinate with the provider so as to allow communications from the third party to be verified using an app 100 associated with the provider. Verification for a third party may be based on a subset of factors to those factors upon which verification for the provider is based. A user may be invited to download an app 100 associated with the third party in order to improve the verification process and/or improve a verification score.

The app 100 is capable of verifying other communications other than telephone calls, such as emails, text messages (for example, using Short Message Service (SMS)), instant messages (for example, using services such as WhatsApp® and Facebook Messenger®), audio messages (such as voicemail), or video messages (for example, using services such as Snapchat®). In these cases, the information related to the identity of a communicating party 104 is a user name, an identifying address (such as an email address), or caller ID information (for use with text messages or certain instant messaging services, such as WhatsApp®, which use caller ID information as an indicator of identity). The app 100 receives a priming signal 103 having scheduling information relating to an initial message, or an authentication sequence is included in the information related to the identity of a communicating party 104. The authentication sequence may comprise letters or words as well or as an alternative to numbers. An example of an email address incorporating an authentication code is thdhdhkahjdcK980U329837@bank(dot)com′. The information identifying the communicating party 104 is manipulated directly in order to incorporate an authentication sequence.

If an initial message is verified and the interaction between the provider and user develops into a conversation, the entire conversation is verified. This is suitable for media in which interaction typically takes place over a relatively fast timescale, such as instant messaging. A time-out in which no messages are received from the provider is provided, after which the conversation is no longer verified and a new priming signal 103 is required. Alternatively, messages are verified on a per-message basis. This is suitable for media in which interaction typically takes place over a relatively slow timescale, such as email. It may also be suitable for on the fly verification in near real time. The user is informed that the interaction is verified or unverified via a notification generated by the app 100, a message arranged to appear within the application or web browser that the user uses to receive and send communications (such as ‘verified communication’ or ‘caution—unverified communication’), or an item of media content 105 arranged to overlay a portion of the application or web browser, in a similar way to the previously described item of media content 105 being arranged to overlay the call screen 104. The user is informed that the interaction is verified or unverified by selection of a specific audio signal or ringtone.

It will be understood that any feature of the verification system 1 that has been described by reference to telephone calls may be applied for other types of communications, including but not limited to the communications detailed above.

It will be understood that although the verification system 1 has been described above largely by reference to a communication apparatus 15, such as a call centre, communicating with an individual client device 10, the verification system 1 can equally be applied to other use cases. For example, the verification system 1 may be used by two users having ordinary smartphones or other client devices so as to verify each other's identity in communications. Furthermore, the verification system 1 may be used to verify a user's communication with a large organisation, such as when the user communicates with a call centre via a telephone call or an automated online assistant via an instant messaging service. In order to provide the functionality described above, in a bank branch office for example, or a call centre, a hardware decoding device can be attached to telephone apparatus. The hardware decoding device is adapted to provide the same functions as the app described above with reference to a smartphone. Such a hardware decoding device can provide verification functionalities to a communication device that is not a smart phone, such as a landline telephone. The hardware decoding device can similarly be adapted to block calls or indicate caller verification by way of an audio signal or an optical signal such as a light. The hardware decoding device can similarly be adapted to receive verification information, for example a priming signal with scheduling information as described above, for example as sent from a client device or as received from a web-based scheduling portal.

It will be appreciated that the described app 100 (or certain modules of the app 100) may alternatively be provided as a software application external to the user device 10, where the user device 10 is operable to communicate with the external software application. Similarly, certain components or modules of the telephone apparatus 15 may be provided external to the telephone apparatus, where the telephone apparatus is in communication with the external components or modules.

It will be understood that the invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

1-75. (canceled)

76. A method of verifying the identity of a communicating party at a user device, the method comprising the steps of:
receiving a communication at the user device, wherein the communication comprises information identifying the communicating party;
determining whether the information identifying the communicating party comprises a variable authentication sequence indicative of the identity of the communicating party; and
comparing the authentication sequence against at least one pre-determined criteria to determine whether the authentication sequence is valid, thereby to verify the identity of the communicating party.

77. A method according to claim 76, further comprising generating the authentication sequence using an algorithm, wherein the at least one pre-determined criteria are arranged so as to allow determination of whether the authentication sequence is a valid sequence generated by the algorithm; preferably wherein the authentication sequence is generated on the basis of one or more properties associated with the user device and/or user; more preferably wherein the one or more properties comprise one or more of: a property associated with the user device, an app user identification number, a user telephone IMEI (International Mobile Equipment Identity) number, a user telephone number, or a secret key associated with the user.

78. A method according to claim 77, wherein the authentication sequence is generated on the basis of one or more dynamic properties; preferably wherein at least one of the dynamic properties relates to time.

79. A method according to claim 77, wherein the at least one pre-determined criteria comprise a further algorithm being arranged to determine whether the authentication sequence is a valid sequence generated by the algorithm.

80. A method according to claim 79, wherein the further algorithm is arranged to calculate an inverse function of the algorithm.

81. A method according to claim 79, wherein the further algorithm is arranged to determine whether the authentication sequence is a valid sequence based on the same properties that the authentication sequence is based on, wherein the properties are calculated independently by the algorithm and the further algorithm.

82. A method according to claim 77, further comprising updating the at least one pre-determined criteria in dependence on changes to the algorithm.

83. A method according to claim 76, further comprising generating an authentication sequence at random.

84. A method according to claim 76, wherein the at least one pre-determined criteria comprise a list of possible valid authentication sequences.

85. A method according to claim 76, wherein the authentication sequence is selected from a plurality of possible authentication sequences, optionally based on at least one parameter.

86. A method according to claim 76, further comprising modifying a communication such that the authentication sequence is incorporated into the information identifying the communicating party; and transmitting the modified communication to the user device.

87. A method according to claim 86, wherein the communication is a telephone call and the information identifying the communicating party is caller ID; wherein modifying a communication comprises one of: selecting a telephone number from a list of telephone numbers available to the communicating party, wherein the selected telephone number incorporates the authentication sequence; and
assuming an artificial caller ID for the telephone call, wherein the assumed artificial caller ID incorporates the authentication sequence.

88. A method according to claim 87, wherein the assumed artificial caller ID is in an invalid format for a telephone number.

89. A method according to claim 87, wherein the assumed artificial caller ID is arranged so as to look like a valid telephone number.

90. A method according to claim 86, wherein modifying a communication comprises encoding the authentication sequence into the information identifying the communicating party.

91. A method of verifying the identity of a communicating party at a user device, the method comprising the steps of:
receiving a verification signal from a communicating party at a user device, wherein the verification signal specifies one or more conditions relating to a communication from the communicating party;
receiving a communication at the user device, wherein the communication comprises information identifying the communicating party; and
determining whether the communication satisfies the specified one or more conditions thereby to verify the identity of the communicating party.

92. A method according to claim 91, wherein the communication is a telephone call and the information identifying the communicating party is caller ID information; wherein the method further comprises displaying whether the identity of the communicating party has been verified on an incoming call screen of the user device.

93. A method according to claim 91, further comprising blocking the communication upon determining that the communication does not satisfy the one or more conditions.

94. A method according to claim 76, further comprising indicating whether the identity of the communicating party has been verified to a user; wherein indicating whether the identity of the communicating party has been verified comprises one or more of: displaying a message; and playing an audio clip.

95. A method according to claim 94, wherein the message comprises an item of media content; preferably wherein the method further comprises detecting a user interaction with the user device in response to the item of media content; and transmitting information relating to the user interaction to the communicating party; more preferably wherein the information relating to the user interaction comprises one or more of: a communication, a schedule for a further communication, a selection of an option, and/or a request for a further communication via an alternative communication medium.

96. Apparatus for verifying the identity of a communicating party at a user device, comprising:
a module for receiving a communication at the user device, wherein the communication comprises information identifying the communicating party; and
a module for determining whether the information identifying the communicating party comprises a variable authentication sequence indicative of the identity of the communicating party;
a module for comparing the authentication sequence against at least one pre-determined criteria to determine whether the authentication sequence is valid, thereby to verify the identity of the communicating party.

97. Apparatus for verifiably communicating with a user device, comprising:
a module for generating an authentication sequence for incorporation into a communication;
a module for modifying a communication, wherein the communication comprises information identifying the communicating party and wherein the module for modifying a communication is operable to modify the information to incorporate the authentication sequence; and
a module for transmitting the modified communication to the user device.

98. A system for verifying the identity of a communicating party at a user device; comprising:
apparatus for verifying the identity of a communicating party at a user device, comprising:
a module for receiving a communication at the user device, wherein the communication comprises information identifying the communicating party; and
a module for determining whether the information identifying the communicating party comprises a variable authentication sequence indicative of the identity of the communicating party;
a module for comparing the authentication sequence against at least one pre-determined criteria to determine whether the authentication sequence is valid, thereby to verify the identity of the communicating party; and
apparatus for verifiably communicating with a user device, comprising:
a module for generating an authentication sequence for incorporation into a communication;
a module for modifying a communication, wherein the communication comprises information identifying the communicating party and wherein the module for modifying a communication is operable to modify the information to incorporate the authentication sequence; and
a module for transmitting the modified communication to the user device.

99. Apparatus for verifying the identity of a communicating party at a user device; comprising:
a module for receiving a verification signal from a communicating party at a user device, wherein the verification signal specifies one or more conditions relating to a communication from the communicating party;
a module for receiving a communication at the user device, wherein the communication comprises information identifying the communicating party; and
a module for determining whether the communication satisfies the specified one or more conditions thereby to verify the identity of the communicating party.

100. A system for verifying the identity of a communicating party at a user device; comprising:
apparatus as claimed in claim 99;
a communication apparatus for sending a priming signal; and
a communication apparatus for sending a communication.
